(19) United States
(12) Patent Application Publication
(10) Pub. No.: US 2025/0058832 A1
(43) Pub. Date: Feb. 20, 2025

(54) WINDOW AND/OR ROOF FRAME FOR A MOTOR VEHICLE

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/806,887

(22) Filed: Aug. 16, 2024

(30) Foreign Application Priority Data
Aug. 17, 2023 (DE) 10 2023 122 062.4

(51) Int. Cl. B62D 25/06; B62D 25/04

(52) U.S. Cl. CPC B62D 25/06; B62D 25/04

(57) ABSTRACT

A window and/or roof frame for an automobile, which has at least two bows running transversely to a direction of travel and at least two longitudinal members, wherein the window and/or roof frame is produced as a one-piece sheet metal formed component from a single blank in one press stroke. Different wall thicknesses and/or strengths are formed locally, wherein the wall thicknesses or tensile strengths differ by at least 10%.

### RELATED APPLICATIONS

The present application claims priority of German Application Number 10 2023 122 062.4 filed Aug. 17, 2023, the disclosure of which is hereby incorporated by reference herein in its entirety.

### FIELD

The present disclosure relates to a window and/or roof frame for a motor vehicle.

### BACKGROUND

Instead of a motor vehicle, one can also speak of an automobile, which is able to be a motorized vehicle with an internal combustion engine, but also a motor vehicle that has an electric drive or another energy source to operate the drive.

Such motor vehicles or automobiles have been manufactured for many years with a so-called self-supporting body. Such a body is welded together from individual metal components, e.g., steel components, but in also aluminum components. The individual components of the self-supporting body, for example, an A-pillar, a B-pillar, longitudinal members, cross members and bows, are manufactured as individual press-formed components and then coupled together, e.g., welded, so that a self-supporting body is created.

Roof frames for motor vehicles are described in DE 10 2014 206 196 A1 and DE 10 2017 220 744 B3.

### SUMMARY

The object of the present disclosure provides a window and/or roof frame which is able to be manufactured cost-effectively in terms of production technology, with targeted crash properties and at the same time high strength.

In at least one embodiment of the disclosure, a window and/or roof frame is provided for an automobile or motor vehicle. The window or roof frame includes at least two bows running transversely to a direction of travel and at least two longitudinal members are formed. The longitudinal members are oriented along a longitudinal direction thereof in the longitudinal direction of the vehicle. The window and/or roof frame is manufactured as a one-piece sheet metal component in one press stroke. In at least one embodiment of the disclosure, locally different wall thicknesses and/or strengths are formed in the material. Two adjacent different wall thicknesses differ from each other by at least 10%.

There is a transition region between the two wall thicknesses. This is able to be a flowing pattern if the blank has been rolled, for example. The transition region is able to be designed in steps. In the case of a Tailored Welded Blank, welded together. The adjacent regions are able to differ from each other in tensile strength by at least 10%. However, the tensile strength and/or wall thickness should not differ from each other by more than 200%, and not more than 100%.

Sheet metal forming is a bending process in a forming press. In at least one embodiment of the disclosure, sheet metal forming is able to be a deep-drawing process. According to the disclosure, a blank is first provided. The blank is able to be made from a single piece of material. However, the blank is able to be made in one piece, i.e., as a welded assembly part or as a so-called Tailored Welded Blank (TWB). Different wall thicknesses in the blank itself are able to be based on different individual parts, which are then welded together in one piece to form a Tailor Welded Blank. The entire blank is then placed in a press, also called a gigapress. The blank has an external dimension of greater than 100 cm×100 cm. The blank is then formed in a press, for example, in one press stroke.

The method according to the disclosure offers a high level of precision for the manufactured component. A component that would otherwise have to be assembled from various individual smaller components as a so-called assembly is manufactured in one piece with just one press stroke. The resulting geometric precision of the component is high, since three, four or more individual components do not have to be reassembled after forming operations. At the same time, production costs are low, as individual forming processes for smaller individual components are eliminated and everything is able to be performed in one forming process in a gigapress. In at least one embodiment of the disclosure, a forming process takes place in one press stroke, which is used in the final shaping of the entire large component. This means that calibration also takes place at the same time. Through various nodes, for example, in the form of the A-pillar, B-pillar, the longitudinal roof members but also the transverse bows running across them, calibration is performed simultaneously not only in the press stroke direction, but also in the forming direction, which corresponds to the vertical direction of the vehicle. At the same time, calibration takes place in the longitudinal and transverse directions of the vehicle, i.e., in the X and Y directions. In at least one embodiment of the disclosure, calibration does not take place here by pure forming in the forming direction, but rather a calibration in such a way that the components are also stretched or compressed due to the nodes in the later transverse or longitudinal direction of the vehicle, thus, oriented orthogonally to the press stroke direction and forming direction.

In at least one embodiment of the disclosure, regions with different wall thicknesses and/or strengths are able to be defined. In the component later produced by the forming process, these regions are then arranged with precision. In at least one embodiment of the disclosure, using hot forming press hardening technology, setting different strengths in the material through so-called Tailored Tempering is able to be performed. The component is therefore made, at least in sections, from a hardenable steel alloy. For example, the component could be a boron-manganese steel to which hot forming press hardening technology is applied.

For example, local heat treatment is able to occur in the hot forming process. This local heat treatment is able to be integrated into the hot forming press hardening process; for example, regions that are later to have a softer material structure are able to be heated to a lesser extent or not at all, or able to be cooled at a lower quenching rate and thus hardened less, thus creating softer regions, so-called soft zones. By integrating these regions a forming process, the geometric precision of these soft zones is able to be increased.

Another possibility for realizing different tensile strengths when using Tailored Welded Blanks is to use different steel grades. Low-alloy steels with a carbon content >0.20% C, for example, in grades 22MnB5 or 36MnB5, are used for the hard, high-strength sections (e.g., later reference marks 8, 9, 6, possibly 5), whereas a boron-manganese steel with a carbon content <0 is used in other, soft or ductile sections 1.15% C, for example, St37 or Ductibor 500 or Ductibor 1000 from Arcelormital. A Tailored Welded Blank plate is able to be used, which is a single blank in the sense of the disclosure, wherein this Tailored Welded Blank plate is welded together from at least two plates of different steel grades or steel compositions to form a single flat, i.e., undeformed blank.

In at least one embodiment of the disclosure, a window frame is manufactured. This is made of two bows running transversely to the direction of travel and two longitudinal members. The bows are also referred to as lower window cross bows or window cross members and upper window cross bows. The longitudinal members are also referred to as A-pillars. In at least one embodiment of the disclosure, the lower window cross member is softer than the A-pillar and/or the upper window cross member. A tensile strength Rm of less than 1000 MPa is for the softer range. The A-pillar and/or the upper window cross member is able to have a tensile strength Rm of greater than 1350 MPa. In at least one embodiment of the disclosure, flanges are able be formed in sections, for example, on the A-pillars or also on the lower window cross member, for example, in the upper window cross member, so that by coupling with a later locking plate, a closed hollow profile is formed at least in length sections and at least partially circumferentially in cross section.

The flanges also have a soft material structure and/or a thinner wall thickness so that they are ductile. In the event of a crash, there is therefore deformation and no tearing or cracking.

Tailored Welded Blanks are able to be Tailored Welded Blanks that are butted together in respective adjacent regions thereof and then joined together using, for example, a laser welding process or a friction stir welding process. However, the blanks are also able to be

Tailored Welded Blanks that overlap in adjacent regions. These Tailored Welded Blanks then form a double layer in the adjacent region, at least in sections. In the overlapping regions, the Tailored Welded Blanks are able to be coupled to one another, for example, by resistance spot welding or another coupling method in the regions of the double layer, for example, by materially bonding.

Due to the hot forming and press hardening of the roof frame, there are no longer any weak points (e.g., cracks, notches, corrosion attacks) in the welds, as would occur when subsequently welding formed and hardened components.

The entire component is able to be coated, with an anti-corrosion coating, which is designed as an aluminum-silicon coating. Here, too, is another advantage. The coating is applied as a pre-coating before the blank is manufactured and is used as scale protection in the hot forming process. In the case of laser-welded Tailored Welded Blanks, the coating in the weld edges has been removed before joining or has been diluted or rendered harmless with welding consumables. In contrast, an overlapping Tailored Welded Blank as mentioned above has the advantage that the edge zones to be welded do not have to be specially treated, whereby the coating is alloyed with the base material during heating or austenitization in the hot forming process. This means that there is little risk of corrosion in the contact regions. The component is thus manufactured to be significantly more durable than components that are subsequently welded individually.

In the case of a roof frame, at least two bows and two longitudinal members are also formed. The longitudinal members are then referred to as roof longitudinal members. In at least one embodiment of the disclosure, the front bow is able to be the upper window cross member. A further bow or roof cross member is then able to be arranged in the region of the B-pillar, in the region of the C-pillar or in the region of the D-pillar, so that a ladder-like structure is formed in plan view. Here, too, the blank is already provided with a relatively large dimension of at least 100 cm×150 cm and is then manufactured as a deep-drawn component in a forming process with, for example, a press stroke. Here, too, the locally different strengths are able to be addressed individually by providing a blank with locally different wall thicknesses and/or different strengths in the material produced before or during the forming process.

In principle, for the purposes of this disclosure, a tensile strength Rm of greater than 1350 MPa is to be assumed for a solid or hard region. In contrast, a soft region or a so-called soft zone has a tensile strength, for example, less than 1000 MPa, or between 500 MPa and 800 MPa.

To further increase strength, a reinforcement patch is applied locally or brought in. The individual cross members and longitudinal members are designed, for example, in respective cross-sections, as deep-drawn components, at least in lengthwise sections, in a U-shaped or V-shaped or hat-shaped manner. A reinforcement patch is able to be introduced into a cavity or interior space of such a U-shaped or V-shaped component. The reinforcement patch is able to already be positioned on the blank. The fixing is performed by an adhesive process or by means of a thermal joining process, for example, welding. The reinforcement patch is then able to be formed together with the rest of the component. Locally, the strength is able to be increased in specific loading sections by inserting a patch.

For the purposes of this disclosure, all measures described above and also measures and individual features described below are able to be combined with one another in one component without departing from the scope of the disclosure, either individually or in respective combinations, without departing from the scope of the disclosure.

### BRIEF DESCRIPTION OF THE DRAWINGS

Further advantages, features, properties, and aspects of the present disclosure are the subject matter of the following description. variants are shown in the individual figures.

These simplify the understanding of the disclosure. Showing

FIG. 1 a combined window and roof frame according to at least one embodiment,

FIG. 2 a manufactured window frame according to at least one embodiment, FIG. 3A and FIG. 3B a Tailored Welded Blank in plan view according to at least one embodiment,

FIG. 3C a window and roof frame in side view according to at least one embodiment,

FIG. 4A, FIG. 4B, FIG. 4C, and FIG. 4D a window and roof frame of a Tailored Welded Blank according to at least one embodiment

FIG. 5A and FIG. 5B a window and roof frame according to at least one embodiment

FIG. 6A and FIG. 6B a Tailored Welded Blank according to at least one embodiment.

### DETAILED DESCRIPTION

In the figures, the same reference numbers are used for individual components, even if a repeated description is omitted for reasons of simplicity.

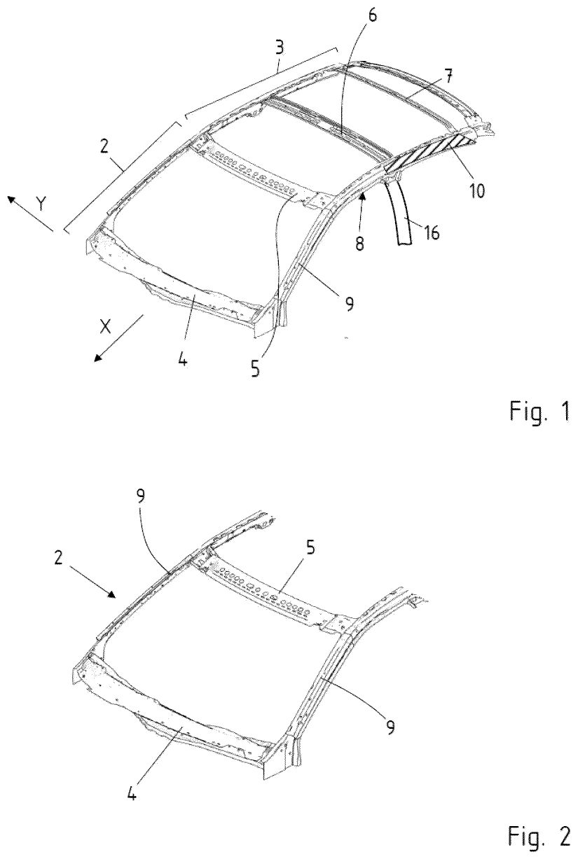

FIG. 1 shows a combined window and roof frame 1. Here, a front region in the vehicle longitudinal direction X is designed as a window frame 2 and an adjoining rear region as a roof frame 3. The window frame 2 has a lower window frame cross member 4 and an upper window frame cross member 5. The window frame cross members 4, 5 are also referred to as bows 6. Furthermore, a middle roof bow 6 in the region of a rear B-pillar 16 and a rear roof bow 7 in the region of a D-pillar (not shown) are each arranged as cross members. Longitudinal members are formed on the sides, also referred to as longitudinal roof members 8. These extend in the vehicle's longitudinal direction X. In the front window frame region, the roof longitudinal member 8 itself is designed as an A-pillar 9. As shown, a soft region 10 is able to be formed in the rear region behind a B-pillar (not shown in more detail) on the longitudinal roof member 8. In the case of a rear-end collision or a rollover of the vehicle, for example, if this region is soft, an improved forming behavior is developed here according to the principle of a crumple zone or crash box which is advantageous, so that crash energy is converted into forming work.

The entire component is manufactured in a forming process with one press stroke, thus, has external dimensions in width, vehicle width in the transverse direction of the vehicle, of more than 100 cm and in length in the longitudinal direction X of the vehicle of more than 200 cm on the finished component. As already mentioned, the entire component was manufactured in one piece in a forming process.

FIG. 2 shows a window frame 2 that has been manufactured. This has a lower window cross member 4 and an upper window cross member 5, as well as an A-pillar 9 to the left and right of the window (not shown in detail). The A-pillar 9 is designed as a hard region with a greater wall thickness and/or a higher strength of more than 1350 MPa. In contrast, at least one of the window frame cross members 4, 5, both, are designed with a thinner wall thickness or a softer strength property, a tensile strength of less than 1000 MPa.

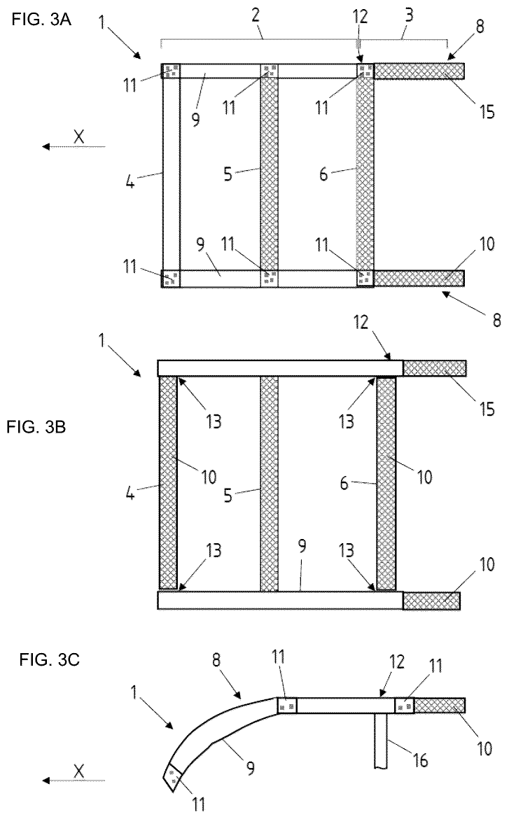

FIG. 3A-FIG. 3C show a further region of a window and roof frame 1 in plan view of FIG. 3A and FIG. 3B in two different embodiments and FIG. 3C in side view. According to the top view of FIG. 3A, a Tailored Welded Blank is manufactured. The lower window frame cross member 4, the upper window frame cross member 5 and the front region of the roof longitudinal member 8 in the form of the A-pillar 9 overlap in regions. Here, in the overlap regions 11 spot welds are shown. The components here are designed in two layers. A rear region of the roof cross member, from passing a connection point 12 for the B-pillar, running rearward in the longitudinal direction of the vehicle, is designed as a soft zone, for example after a bow 6.

FIG. 3B shows an alternative design variant of the otherwise almost identical window and roof frame 1. Tailor Welded Blanks are also formed here. However, these are designed to abut one another in a respective coupling region 13 and are then thermally joined, for example by laser welding or friction stir welding. In contrast to FIG. 3A, there are no overlaps. The lower window frame cross member 4 and the upper window frame cross member 5 are each designed as a soft region 10. Also in the longitudinal direction of the vehicle, an region projecting rearward behind a connection point 12 for the B-pillar. A bow 6 is also formed with a hard material structure, analogous to FIG. 3A.

FIG. 3C shows a side view of the window and roof frame 1 according to the disclosure. The front region of the A-pillar 9 of the roof longitudinal member 8 is formed with a hard material structure and/or greater wall thickness up to a connection point of the B-pillar 12. A section extending rearward in the longitudinal direction X of the vehicle is designed as a soft zone of the longitudinal roof member 8.

For this example, but also for other examples and for the general description, the wall thicknesses and/or strength of two adjacent regions differ by at least 10%, between 15% and 60%, and between 20% and 50%. This applies to roof racks, bows and A-pillars, wherein, depending on the segment, the wall thickness, without a reinforcement patch, is 1 mm to 3 mm, or 1.4 mm to 2.4 mm. The respective percentage distinction within the aforementioned limits then applies accordingly.

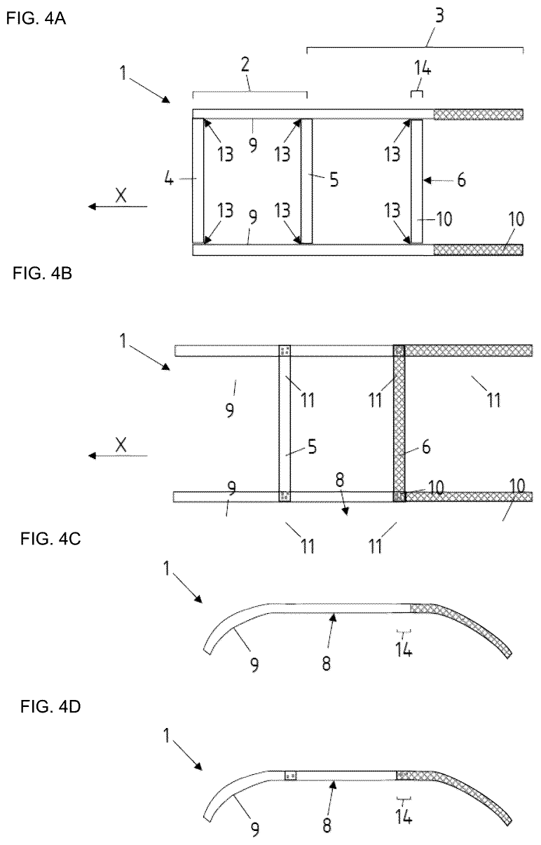

FIG. 4A, FIG. 4B, FIG. 4C, and FIG. 4D show an alternative design variant of the window and roof frame 1 according to the disclosure. In the case of FIG. 4A, a Tailored Welded Blank is shown, which lies butt-fittingly and is welded together at the respective connection points between the lower roof cross member, the upper roof cross member and in the rear region of the roof bow 6. Furthermore, in the region of a connection point of the C-pillar 14 in the longitudinal direction of the vehicle, a soft region with a lower strength and/or lower wall thickness is formed. The rear roof bow 6 in the arrangement region of the C-pillar 14 is also designed as a soft region with a smaller wall thickness and/or lower strength.

FIG. 4B shows an alternative design variant. A combined window and roof frame 1 is also shown here. However, this is designed without the lower window cross member 4, 5. An upper window cross member 5 and a rear roof bow 7 are formed, thus at least two cross members 4, 5. The individual connection points are each formed with overlapping regions 11 and indicated spot welds. A rear region of the longitudinal roof members 8 in the longitudinal direction of the vehicle as well as the roof bow 6 itself are designed as a soft region.

FIG. 4C shows the window and roof frame 1 according to the disclosure from FIG. 4A in side view, FIG. 4D shows a window and roof frame 1 according to FIG. 4B in side view.

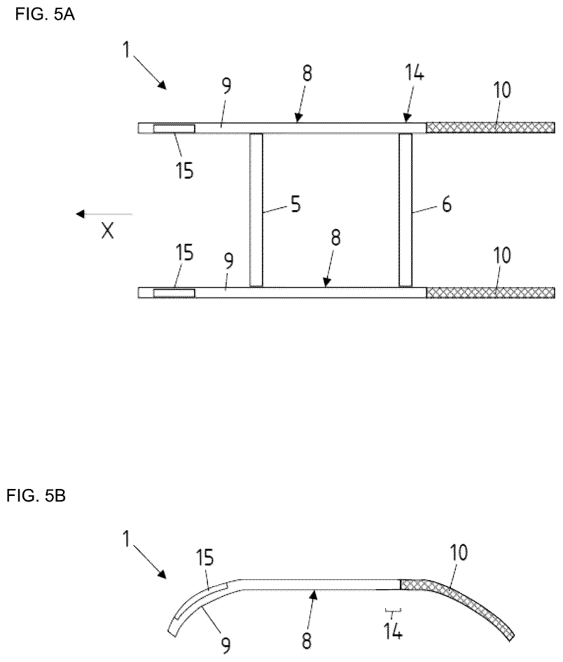

FIG. 5A and FIG. 5B show a further embodiment of a window and roof frame 1 according to the disclosure in plan view and in side view. A reinforcement patch 15 is incorporated in the front region of the A-pillar 9. This reinforcement patch 15 provides a local increase in strength in the region of the window frame. The upper window cross member 5 as well as the roof bow 6 and a front region in the vehicle longitudinal direction X of the roof longitudinal member 8 are each designed as a hard region. An adjoining region from passing the C-pillar further to the rear in the vehicle's longitudinal direction X is a soft region. Here, the crash properties are able to be improved to such an extent that a crumple zone is created.

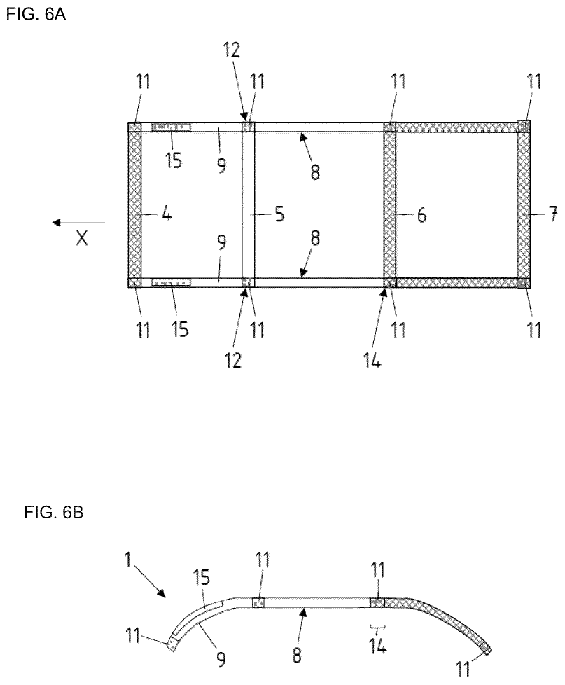

FIG. 6A and FIG. 6B show alternative design variant. Here, too, in the lower front region relative to the vehicle longitudinal direction X, reinforcement patches 15 are introduced into the A-pillars 9. A front or lower window cross member 4, 5 is designed as a soft region. In relation thereto, an upper disc cross member 5 is designed as a hard region. A subsequent roof bow 6 in the region of the connection of the C-pillar 14 as well as a rear roof bow 6 in the region of the D-pillar or as the upper end edge of a rear lid are also designed as a soft region, just like the rear part of the longitudinal roof cross member 8 extending between them. In the case of FIG. 6A and FIG. 6B, the blank and thus also the manufactured component is again shown as a Tailored Welded Blank with local overlapping regions 11. These are spot welded to prepare the blank. In the connection regions 12, 14, for example, a stable and high-strength connection of the B-pillar or C-pillar is ensured due to the doubling of materials.

The steel grades are able to be used as examples below and are able to used for all variants of this disclosure. Different types of steel are able to be combined in a Tailored Welded Blank. The corresponding strength ranges for hard or soft zones or solid or ductile regions are able to be found in the table. All alloy components are given in wt. %, wherein the respective hardenable steel alloy then contains the remaining iron and impurities resulting from the melting process.

| | C | | Si | | Mn | | P | S | Al | | B | | Cr |
|---|---|---|---|---|---|---|---|---|---|---|---|---|---|
| | min | max | min | max | min | max | max | max | min | max | min | max | min |
| Stahl A | 0.19 | 0.25 | 0.1 | 0.4 | 1.1 | 1.4 | 0.02 | 0.005 | 0 | 0.06 | 0.004 | 0.1 | |
| Stahl B | 0.2 | 0.23 | 0.2 | 0.3 | 1.1 | 1.4 | 0.02 | 0.005 | 0 | 0.06 | 0.004 | 0.1 | 0.1 |
| Stahl C | 0.31 | 0.37 | 0.1 | 0.6 | 1 | 1.5 | 0.025 | 0.02 | | 0.1 | 0.001 | 0.004 | 0.08 |
| Stahl D | 0.33 | 0.35 | 0.15 | 0.35 | 1 | 1.5 | 0.025 | 0.015 | 0.01 | 0.08 | 0.001 | 0.004 | 0.08 |
| Stahl E | 0.06 | 0.13 | | 0.7 | | 1.9 | 0.05 | 0.05 | | 0.1 | | 0.003 | |
| Stahl F | 0.07 | 0.11 | 0.02 | 0.6 | 1.2 | 1.6 | 0.03 | 0.01 | 0.01 | 0.07 | 0.0007 | 0.002 | |

| | | Cu | N | Nb | | Ni | | Ti | | V | Mo |
|---|---|---|---|---|---|---|---|---|---|---|---|
| | max | max | max | min | max | min | max | min | max | max | max |
| Stahl A | 0.3 | 0.1 | | | 0.05-Ti | 0.02 | 0.1 | 0.01 | 0.1 | | 0.35 |
| Stahl B | 0.3 | 0.1 | 0.01 | | 0.05-Ti | 0.02 | 0.1 | 0.02 | 0.05 | 0.01 | 0.35 |
| Stahl C | 0.35 | 0.2 | 0.2 | | 0.1 | | 0.2 | 0.002 | 0.05 | | 0.35 |
| Stahl D | 0.5-Mo | 0.2 | 0.2 | 0.01 | 0.06 | | 0.2 | 0.005 | 0.015 | 0.01 | 0.5-Cr |
| Stahl E | 0.15 | 0.2 | 0.2 | | 0.1 | | | | 1.2 | 0.1 | 0.1 |
| Stahl F | 0.15 | 0.2 | 0.2 | 0.04 | 0.1 | | | 0.03 | 0.2 | 0.1 | 0.1 |

1-16. (canceled)

17. A window or roof frame of an automobile, comprising:
at least two bows running transversely relative to a direction of travel of the automobile; and
at least two longitudinal members, wherein the window or roof frame is a one-piece sheet metal component the one-piece sheet metal component having different wall thicknesses or tensile strengths Rm which differ by at least 10%.

18. The window or roof frame according to claim 17, wherein the window frame comprises a lower bow, an upper bow, and two A-pillars.

19. The window or roof frame according to claim 17, wherein the window or roof frame comprises a front bow, and at least one middle or rear bow, and longitudinal roof members running laterally in a longitudinal direction (X) of the motor vehicle.

20. The window or roof frame according to claim 17, wherein the window or roof frame comprises a Tailored Welded Blank material having regions with mutually different wall thicknesses or overlap regions.

21. The window or roof frame according to claim 17, is a hot forming and press-hardening component.

22. The roof frame according to claim 17, wherein the tensile strength of a high strength region is greater than or equal to 1350 MPa.

23. The window or roof frame according to claim 17, wherein a region in a longitudinal direction (X) of the motor vehicle behind the B-pillar is a soft region less than 1000 MPa.

24. The window or roof frame according to claim 23, wherein the longitudinal roof members extend in the longitudinal direction (X) of the motor vehicle behind the B-pillar are soft.

25. The window or roof frame according to claim 17, wherein a lower window frame cross member is soft.

26. The window or roof frame according to claim 25, wherein the lower window frame cross member has a tensile strength Rm of less than 1000 MPa.

27. The window or roof frame according to claim 17, further comprising connecting flanges which have a tensile strength Rm of less than 1000 MPa.

28. The window or roof frame according to claim 27, wherein the connecting flanges have a tensile strength Rm of less than 850 MPa.

29. The window or roof frame according to claim 17, wherein a reinforcing patch is applied at least locally in a node region between a roof bow and A-pillar, bow and longitudinal roof member running in the longitudinal direction of the motor vehicle, wherein the reinforcing patch is L-shaped or T-shaped.

30. The window or roof frame according to claim 29, wherein a reinforcing patch is applied in a node region between the roof bow and the A-pillar, bow.

31. The window or roof frame according to claim 29, wherein a reinforcing patch is applied in the longitudinal direction (X) of the motor vehicle in the longitudinal roof member.

32. The window or roof frame according to claim 29, wherein the reinforcing patch is L-shaped or T-shaped.
